(19) United States
(12) Patent Application Publication
(10) Pub. No.: US 2008/0038426 A1
(43) Pub. Date: Feb. 14, 2008

(54) Method For Producing Portions Of Meat

(76) Inventors: Petra Groneberg-Nienstedt, Haltern (DE); Jorg Rosenberger, Reken (DE)

Correspondence Address: K.F. ROSS P.C., 5683 RIVERDALE AVENUE, SUITE 203 BOX 900, BRONX, NY, 10471-0900, US

(21) Appl. No.: 11/791,177

(22) PCT Filed: Sep. 17, 2005
(86) PCT No.: PCT/EP05/10059

§ 371 Date: May 16, 2007

(30) Foreign Application Priority Data
Nov. 16, 2004 (DE) 10 2004 055 345.9

(51) Int. Cl. A22C 7/00

(52) U.S. Cl. 426/513

(57) ABSTRACT

The invention relates to a method for producing portions of meat that are identical in shape and weight by compacting frozen meat in a mold to form a rounded final shape. An individual piece of meat, which has its natural shape and to which no other pieces of meat adhere, is, when frozen or not frozen, divided, in particular, sawn into two, three or more portion that are equal in weight and/or until the desired weight is obtained. In addition, each portion is trimmed until it has a desired weight and, preferable, a desired rough shape (pre-shape) and is then, while frozen, placed inside the mold and compacted into the final shape inside the mold.

The invention relates to a method for producing meat portions of the same shape and mass by pressing frozen meat in a mold into a rounded final shape.

In this case, the word “meat” is taken to mean not only any animal meat such as poultry, beef, pork, or lamb, but also the flesh of fish. The food industry wants meat in whole, homogeneous pieces that have an identical shape, apart from being uniform in mass. As a result, these pieces have the same thickness and cross sections to permit automatic cooking with identical cooking times. At the same time, it is advantageous to make the shape such that the meat pieces give the impression of being large when served, that is, have the largest possible cross section.

It is known in the art to saw squarish chunks from frozen blocks that contain a plurality of meat pieces, and to place these while still frozen into a mold and there to press them. Because of the squarish shape, it is necessary to produce substantial deformation during pressing to obtain a rounded final piece that resembles a natural piece of meat. The displacement of the muscle fibers is so considerable that the fiber structure is not sufficiently retained. Furthermore, reshaping is problematic when the starting product has such large dimensions so that large volumes of waste result during cutting to size.

The object of the invention is to transform meat portions of equal mass but with different initial shapes and sizes into meat pieces of equal mass with identical and stable shapes, and at the same time to largely preserve the fiber structures.

The object is achieved according to the invention in that a single piece of meat, having its natural shape and to which no other pieces of meat adhere, is divided, especially sawn, in a frozen or unfrozen state into two, three, or more portions of equal weight and/or desired weight, and that each portion is trimmed until it has a desired weight and preferably a desired rough shape (preliminary shape) and then placed in the mold in the frozen state and pressed in the mold into the final shape.

The method makes it possible, regardless of the size of the original piece of meat and thereby also in the case of pieces of meat of very larger size and mass, to obtain the final shape, particularly with double or multiple mass or size, of meat portions that always have the same shape and mass and the same weight. The muscle fiber structures are largely preserved, so that the bite in such meat pieces corresponds to that in natural meat pieces. Because the thicknesses and cross sections are always the same, the cooking times are always the same and furthermore shapes may be selected that allow the meat portions to appear large when served; in other words, they have a relatively large cross section. In principle, the shape can be preselected as desired.

Preferably, it is proposed that the meat pieces during placement in the mold have a temperature of −5° C. to −20° C. It is especially advantageous that before pressing and/or trimming the meat pieces are pretreated in tumblers and/or by placement in sauces or marinades or spices or by injection.

Illustrated embodiments of the method of the invention are described in greater detail hereafter.

In the drawing:

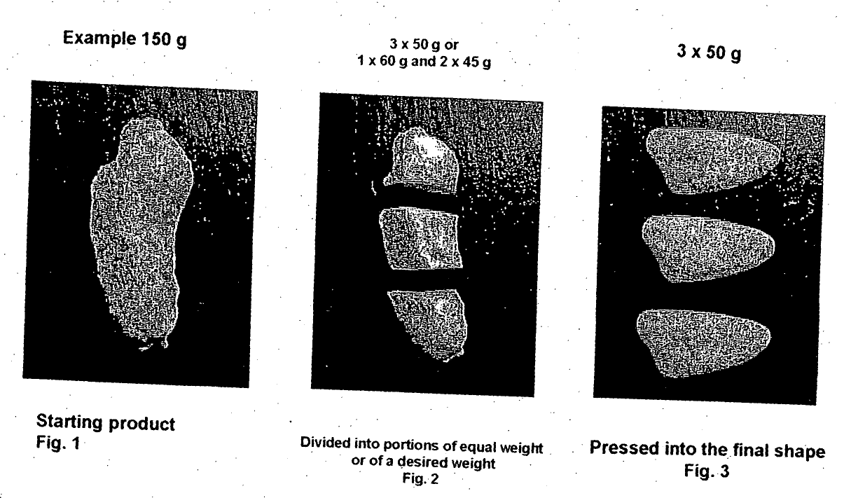

FIG. 1 shows a large piece of meat as the starting product;

FIG. 2 shows the piece of meat divided into portions; and

FIG. 3 shows the portions after pressing into their final shape.

A large piece of muscle meat from an animal, particularly poultry, beef, pork, lamb, or fish, with twice or many times the size or weight of the final meat portion is frozen in its natural form. “Natural form” is taken to mean that the meat piece was not changed so greatly by pressing, cutting, or sawing that the shape predetermined by the muscle is no longer recognizable. A no longer recognizable shape of this type is produced, for example, when block-shaped pieces are sawn from a frozen block of meat.

The large piece of meat, depending on size and weight, is cut into two, three, or more portions of equal weight that correspond to the target weight. The dividing by cutting does not occur in the frozen state. Preferably, however, the piece of meat is frozen (−5 to −20° C.) and sawn into portions. The deep-frozen meat portion is then placed in the tray of a pressing mold that has a greater length than width and a smaller height than width, the edges being rounded and one end of the elongated mold having a different curved shape than the opposite end. This way, the tray has approximately the natural shape of a piece of muscle meat with a slightly vaulted top and bottom side.

After the meat portions are placed in the mold, a ram is pressed down on the mold and thereby pressure is exerted on the meat to press the meat material in its frozen state until the meat material fills the entire mold and at the same time the muscle fibers are displaced relative to each other. In this case, the final product remains stable in shape.

The initial temperature of the meat portions in this case is preferably −5° C. to −20° C. The method forming the basis of the shaping process with use of pressure is known from the German patent publications DE 19806391 A1 and DE 19732206 C1. The loading of the trays occurs manually or automatically. The method does not depend on the special geometry of the starting material, as is the case, for example, in blanks sawn from deep-frozen blocks. In particular, a special preshaping step in a mold that is similar to the desired final shape is not necessary. It is only necessary that the meat portions fit in the tray used for the shaping in a way suitable for the method, in other words, that particularly its cross section is not greater than that of the tray. This can occur preferably by suitable freezing of the meat portions with geometric restrictions (such as, for example, in suitable containers), no use of pressure being required. The starting products can therefore be frozen under atmospheric pressure.

The meat portions to be shaped are preferably whole pieces or combinations of products cut into pieces. They can be untreated or prepared (for example, seasoned, marinated, provided with food additives) or pretreated (for example, by injection or processing in tumblers).

Before the meat portion is placed in the mold, it may be trimmed to maintain the desired weight or the desired volume that is necessary for the specific mold. As a rule, however, this requires only a few cuts at the edge of the meat portion. Otherwise, the meat portion remains in its natural muscle shape.

1. A method for producing meat portions of the same shape and mass by pressing frozen meat in a mold into a rounded final shape, characterized in that a single piece of meat that has its natural shape and to which no other pieces of meat adhere is divided, especially sawn, in a frozen or unfrozen state into two, three, or more portions of equal weight and/or desired weight, and that each portion is trimmed until it has a desired weight and preferably a desired rough shape (preliminary shape) and then placed in the mold in the frozen state and pressed in the mold into the final shape.

2. The method according to claim 1, characterized in that the meat portions during loading into the mold have a temperature of −5° C. to −20° C.

3. The method according to claim 1 or 2, characterized in that, before pressing and/or trimming, the meat pieces or portions are pretreated in tumblers and/or by immersion in sauces or marinades or spices or by injection.
